(19) United States
(12) Patent Application Publication
(10) Pub. No.: US 2006/0006674 A1
(43) Pub. Date: Jan. 12, 2006

(54) Electronic apparatus and magnetic lock device thereof

(75) Inventors: Lunwei Kang, Taipei (TW); Chichung Ho, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/159,138

(22) Filed: Jun. 23, 2005

(30) Foreign Application Priority Data
Jun. 25, 2004 (TW) 093118631

(51) Int. Cl. E05C 17/56

(52) U.S. Cl. 292/251.5

(57) ABSTRACT

A magnetic lock device is separately located on a first body and a second body, which are pivoted with each other. The magnetic lock device comprises a first magnetic element, a second magnetic element, and a control module. The first magnetic element located on the first body comprises a first part and a second part. The first part has a first polarity and the second part has a second polarity. The second magnetic element located on the second body comprises a third part and a fourth part. The polarity of the third part is the first polarity and the polarity of the fourth part is the second polarity. The second polarity is opposite to the first polarity. When the first body and the second body are closed, the first part faces to the fourth part for providing a magnetic attraction between the first body and the second body. The control module is located on the second body. When the control module is triggered, the first part faces to the third part for providing a magnetic repulsion between the first body and the second body.

### BACKGROUND OF THE INVENTION

1. Field of Invention

The invention relates to an electronic apparatus and lock device thereof and, in particular, to an electronic apparatus and magnetic lock device thereof.

2. Related Art

With the coming of the electronic times, the dependence and need of electronic products for people are increasing. In addition, the technology changes with each passing day, so consumers determine whether a product to be bought not only with considering the product's price but also considering the features and friendly use of the product. Therefore, the manufacturers of the electronic products always make the effort to think about how to fit the requirements of consumers.

For understanding the present invention easily, herein the notebook is taken as an example. With reference to FIG. 1, a conventional notebook comprises a monitor 1 and a host 2, which is pivoted on the monitor 1. The screen 12 of the monitor 1 faces to the host 2 and covers the upper surface 22 of the host 2. The notebook further comprises a lock device 4.

The lock device 4 comprises a hook 41, a press-key 42 and a connected part 43. The hook 41 and the press-key 42 of the conventional notebook are located on the front middle of the monitor 1 and the connected part 43 is located on the upper surface 22 of the host 2. When the notebook is in a closed state, the hook 41 is protruding from the monitor 1 and can be fasten to the connected part 43 of the upper surface 22 of the host 2. For opening the notebook, the press-key 42 is pushed to separate the hook 41 and the connected part 43.

The action of opening the notebook is to make the hook 41 disengage from the connected part 43. Thus, the users can exert an outside force between the monitor 1 and the host 2 to separate one another for opening the notebook. However, since the notebook tends toward more thin design, users are still difficult to open it, even the hook 42 is disengaged from the connected part 43, due to the gap between the monitor 1 and the host 2 is too narrow to exert force.

Therefore, according to the mentioned above, it is a subjective to provide a lock device, which is much easily used for users to open the notebook.

### SUMMARY OF THE INVENTION

In view of the foregoing, the invention is to provide an electronic apparatus, which is much easier for user to open the notebook, and magnetic lock device thereof.

To achieve the above, a magnetic lock device of the invention is separately located on a first body and a second body. The first body and the second body are pivoted with each other. The magnetic device comprises a first magnetic element, a second magnetic element, and a control module. In the invention, the first magnetic element is located on the first body and comprises a first part and a second part. The first part has a first polarity and the second part has a second polarity. The second magnetic element is located on the second body and comprises a third part and a fourth part. The third part has the first polarity and the fourth part has the second polarity. The second polarity is opposite to the first polarity. When the first body and the second body are closed, the first part faces to the fourth part for providing a magnetic attraction between the first body and the second body. The control module is located on the second body. When the control module is triggered, the first part faces to the third part for providing a magnetic repulsion between the first body and the second body.

To achieve the above, an electronic apparatus of the invention comprises a first body, a second body, a first magnetic element, a second magnetic element, and a control module. In the invention, the first body and the second body are pivoted with each other. The first magnetic element is located on the first body and comprises a first part and a second part. The first part has a first polarity and the second part has a second polarity. The second magnetic element is located on the second body and comprises a third part and a fourth part. The third part has the first polarity and the fourth part has the second polarity. The second polarity is opposite to the first polarity. When the first body and the second body are closed, the first part faces to the fourth part for providing a magnetic attraction between the first body and the second body. The control module is located on the second body. When the control module is triggered, the first part faces to the third part for providing a magnetic repulsion between the first body and the second body.

As mentioned above, the electronic apparatus and the magnetic lock device thereof of the invention utilize the polarities or locations changing between the first magnetic element and the second magnetic element as well as working on the principle of unlike poles attract. Thus, the first body and the second body that this magnetic lock device is set in are closed because of they are attracted with each other. While working on the principle of like poles repel, the first body and the second body are repelled to separate and then have a gap, which is for users to exert force to open the notebook. Moreover, this invention also provides a lock device, which has designed features as well as makes opening the notebook by one hand possible.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional notebook;

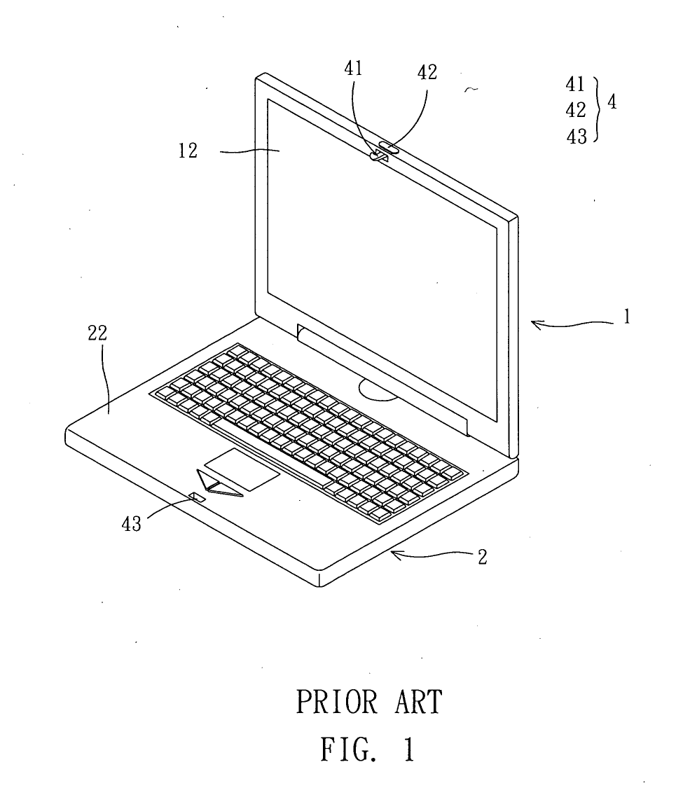

FIG. 2 is a schematic view showing the magnetic lock device according to a preferred embodiment of the invention;

FIG. 3 is an exploded view showing the magnetic lock device according to a preferred embodiment of the invention;

FIG. 4 is a sectional enlarged lateral view showing the magnetic lock device according to a preferred embodiment of the invention;

FIG. 5 is a sectional enlarged lateral view showing the motion of the magnetic lock device according to a preferred embodiment of the invention; and

FIG. 6 is a schematic view showing the magnetic lock device according to another preferred embodiment of the invention.

### DETAILED DESCRIPTION OF THE INVENTION

The present invention will be apparent from the following detailed description, which proceeds with reference to the accompanying drawings, wherein the same references relate to the same elements.

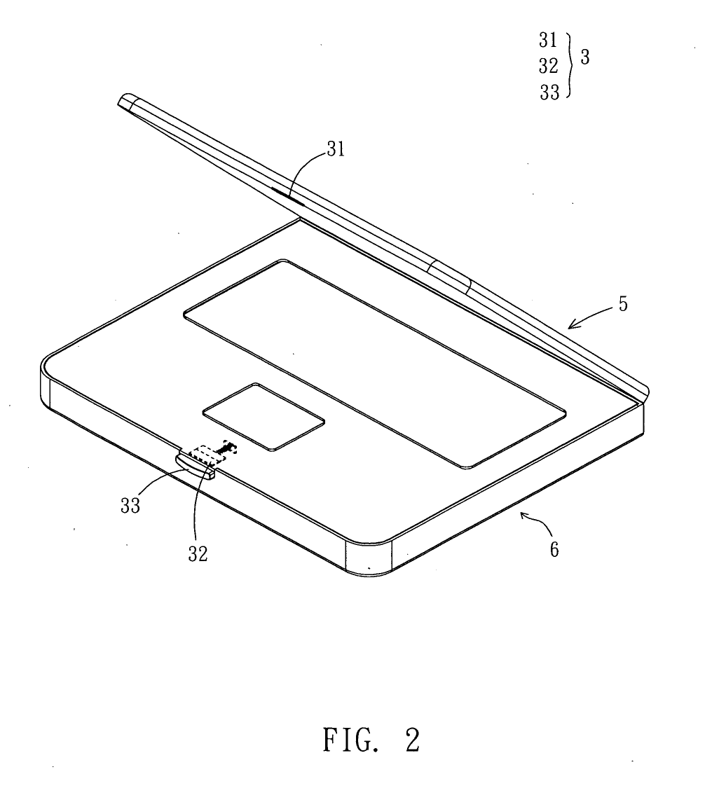

With reference to FIG. 2, the magnetic lock device 3 according to the embodiment of the invention is separately located on a first body 5 and a second body 6. The magnetic lock device 3 comprises a first magnetic element 31, a second magnetic element 32, and a control module 33. The first body 5 is a monitor while the second body 6 is a host. Certainly, the first body 5 also can be a host while the second body 6 is a monitor.

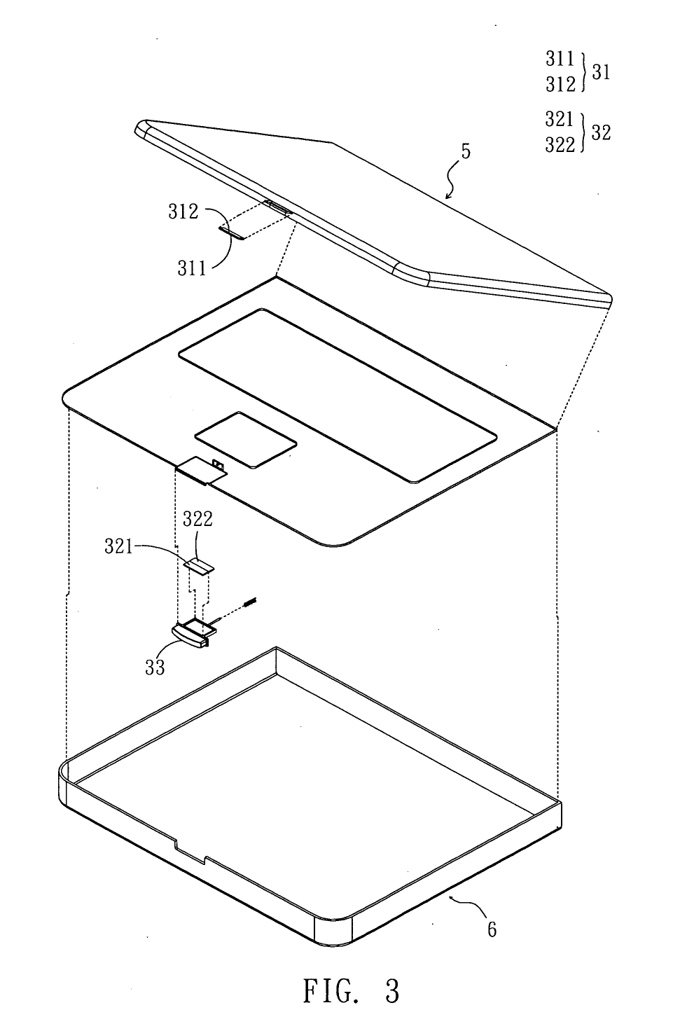

In the present embodiment, as is shown in FIG. 3, the first magnetic element 31, which is located on the first body 5, comprises a first part 311 and a second part 312. The first part 311 has a first polarity and the second part 312 has a second polarity. The second magnetic element 32, which is located on the second body 6, comprises a third part 321 and a fourth part 322. The third part 321 has the first polarity and the fourth part 322 has the second polarity. However, the second polarity is opposite to the first polarity. The first magnetic element 31 and the second magnetic element 32 are magnets. In this case, the first part is the N-pole portion while the second part is the S-pole portion, and the first polarity is normal magnetic polarity while the second polarity is reversed magnetic polarity. Relatively, the first polarity may be reversed magnetic polarity while the second polarity is normal magnetic polarity.

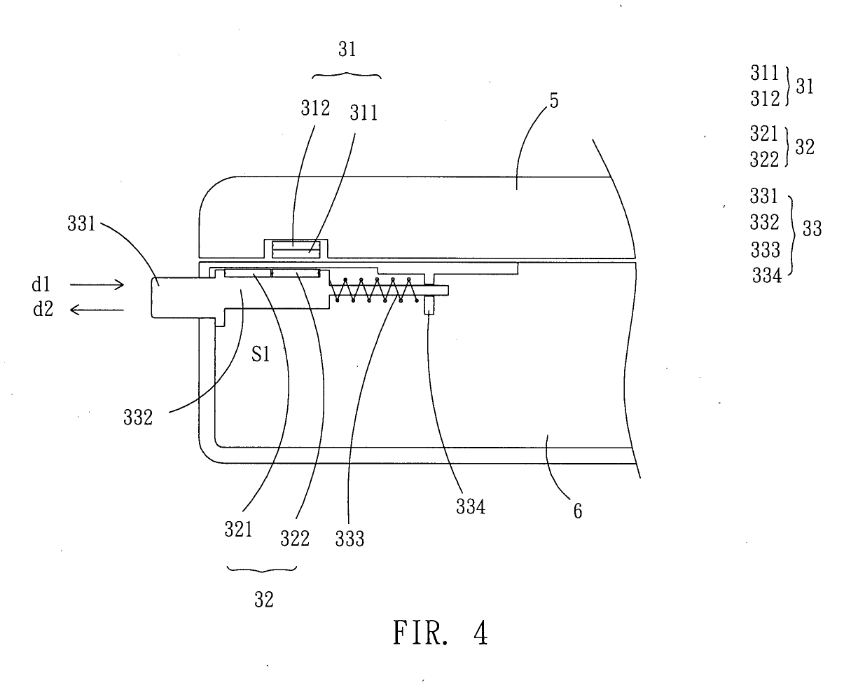

With reference to FIG. 4, when the first body 5 and the second body 6 are closed, the magnetic element 32 is located on a first position S1. And the first part 311 of the first magnetic element 31 faces to the fourth part 322 of the second magnetic element 32. As the polarity of the first part 311 is the first polarity while the polarity of the fourth part 322 is the second polarity and base on the principle of unlike poles attract, a magnetic attraction is, accordingly, provided between the first part 311 and the fourth part 322 to enable the first body 5 and the second body 6 attracting with each other and being in a closed state.

The control module 33 comprises a touch element 331, a bearing element 332, an elastic element 333, and a blocking element 334. In the present embodiment, the touch element 331 and the bearing element 332 are connected. The second magnetic element 32 is set on the bearing element 332. The blocking element 334 is set in the second body 6. The elastic element 333 is located between the blocking element 334 and the bearing element 332. The control module 33 is set on the second body 6. Moreover, the second magnetic element 32 is moved corresponding to the control module 33.

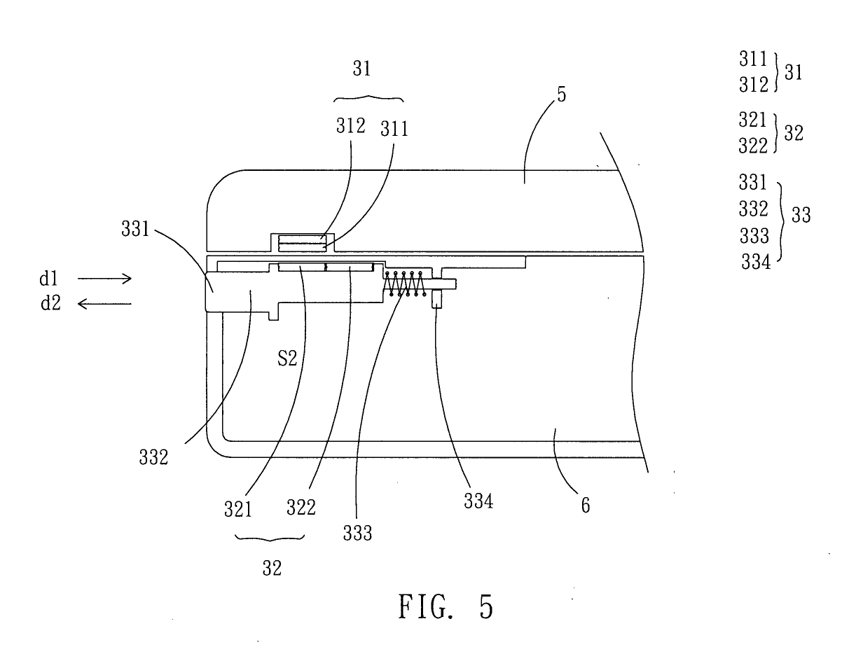

When the touch element 331 of the control module 33 is triggered by a outside force to move in a first direction d1, the second magnetic element 32 set on the bearing element 332 is driven to leave away from the first position S1 to a second position S2 (as is shown in FIG. 5). At this time, the first part 311 of the first magnetic element 31 faces to the third part 321 of the second magnetic element 32. As the polarities of the first part 311 and the third part 321 are the same, there is a magnetic repulsion between the first part 311 and the third part 321. Therefore, the first body 5 and the second body 6 are capable of being separated because of the magnetic repulsion relieving the closed state. When the bearing element 332 moves in the first direction d1 and presses the elastic element 333 located between the bearing element 332 and the blocking element 334, due to the blocking element 334 is fixed in the second body 6 and the movement of the elastic element 333 is restricted by the blocking element 334, the elastic element 333 has a backward elasticity in a second direction d2, which is opposite to the first direction d1 (as is shown in FIG. 4).

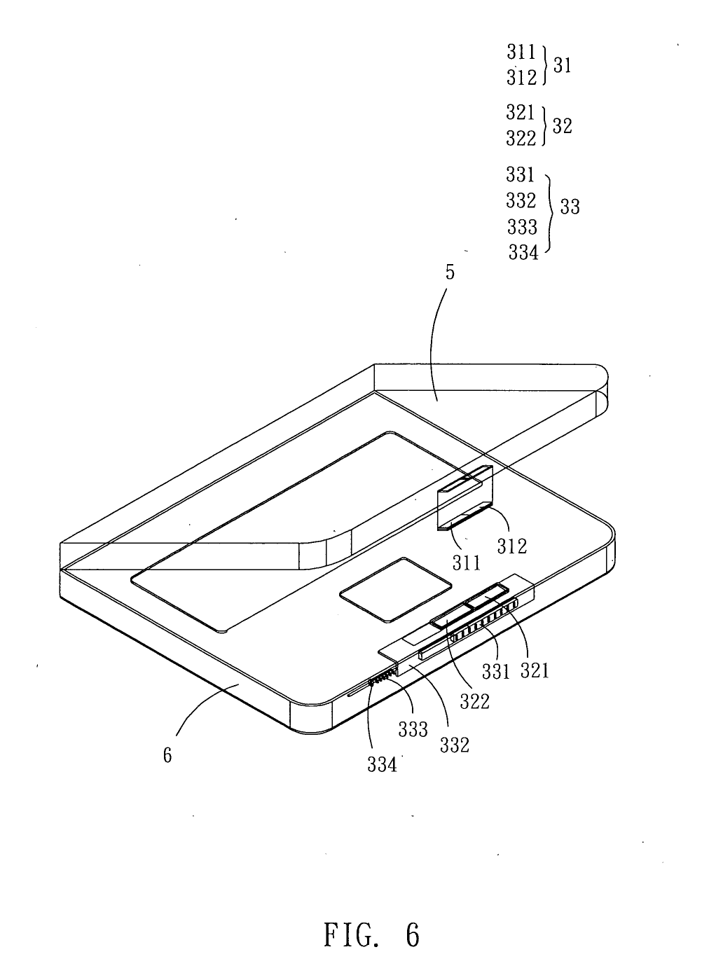

As mentioned above, the touch element 331 of the control module 33 can be a push-button device (as is shown in FIG. 4), and it also can be designed for a press-key device (as is shown in FIG. 6). The elastic element 333 is a spring.

Alternatively, the first magnetic element 31 is also composed of the first part 311 and the second part 312, which are set in parallel (as is shown in FIG. 6).

Additionally, regarding to the magnetic lock device 3 according to another embodiment of the invention, its compositions and dispositions are the same as those mentioned above, so the detailed descriptions are omitted herein. The difference is that the first magnetic element 31 or the second magnetic element 32 can be an electromagnet, which is by means of changing the current to interfere the magnetic effect. By controlling the current to let the polarities of the first magnetic element 31 and the second magnetic element 32 opposite to one another, a magnetic attraction is generated between the first magnetic element 31 and the second magnetic element 32, and then enables the first body 5 and the second body 6 in a closed state. Alternatively, by controlling the current to let the polarities of the first magnetic element 31 and the second magnetic element 32 the same, a magnetic repulsion is generated between the first magnetic element 31 and the second magnetic element 32 and then enables the first body 5 and the second body 6 in a separated state. As mentioned above, the generated magnetic attraction or magnetic repulsion is also base on the principle of unlike poles attract or like poles repel to achieve the first body 5 and the second body 6 in the closed state or in the opened state.

Additionally, the electronic apparatus according to additional embodiment of the invention comprises a first body 5, a second body 6, a first magnetic element 31, a second magnetic element 32, and a control module 33. The first body 5 and the second body 6 are pivoted with each other. When the first body 5 and the second body 6 are closed, the first magnetic element 31 faces to the second magnetic element 32, which is located on the first position S1. Accordingly, a magnetic attraction is generated for making the first body 5 and the second body 6 in a closed state. When the control module 33 drives the second magnetic element 32 to the second position S2, the first magnetic element 31 faces to the second magnetic element 32. Accordingly, a magnetic repulsion is generated. Through the magnetic changes, the first body 5 and the second body 6 repel due to the principle of unlike poles attract. Therefore, the user can easily open the electronic apparatus by exerting a force through the gap between the two bodies.

Due to the structures, the depositions and the actions of the first magnetic element 31, the second magnetic element 32, and the control module 33 in this embodiment are the same as those of the previously mentioned magnetic device 3, the detailed descriptions are omitted for concise purpose. To be noted, the magnetic lock device 3 set on the electronic apparatus can be carried out by a press key or a push button. Moreover, the first magnetic element 31 and the second magnetic element 32 of this lock device are magnets, which can open the computer base on the different magnetic polarities thereof. Furthermore, the first magnetic element 31 or the second magnetic element 32 also can be an electromagnet that has changing polarity caused by the current. As a result, the electromagnet with changed polarity can then interfere the magnetic field for opening the computer.

In conclusion, the magnetic device according to the embodiment of the invention can close the first body and the second body with a magnetic attraction caused by the first magnetic element and the second magnetic whose polarities are unlike. While the first magnetic element and the second magnetic whose polarities are like, a magnetic repulsion is generated to enable the first body and the second body to be separated. The electronic apparatus on which this magnetic lock device is set can not only provide a lock device having a user-friendly design for exerting force easily, but also present a high-quality design feature.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A magnetic lock device, which is separately located on a first body and a second body, wherein the first body and the second body are pivoted with each other, comprising:
a first magnetic element, which is located on the first body and comprises a first part and a second part, wherein the first part has a first polarity and the second part has a second polarity;
a second magnetic element, which is located on the second body and comprises a third part and a fourth part, wherein the third part has the first polarity and the fourth part has the second polarity, the second polarity is opposite to the first polarity, and when the first body and the second body are closed, the first part faces to the fourth part for providing a magnetic attraction between the first body and the second body; and
a control module, which is located on the second body, wherein the control module is triggered to make the first part face to the third part for providing a magnetic repulsion between the first body and the second body.

2. The magnetic lock device of claim 1, wherein the second magnetic element is moved corresponding to the control module, the control module controls the second element to move between a first position and a second position, the first part faces the fourth part when the second magnetic element located on the first position, and the first part faces the third part when the second magnetic element located on the second position.

3. The magnetic lock device of claim 2, wherein the control module comprises a touch element, a bearing element, an elastic element and a blocking element, the touch element connects to the bearing element on which the second magnetic element set, the blocking element is set in the second body, the elastic element is located between the blocking element and the bearing element, when the touch element is moved by a outside force in a first direction and drives the second magnetic element to the second position, the elastic element is moved in a second direction by a backward elasticity of the elastic element due to the elastic element is restricted by the blocking element, the second direction is opposite to the first direction, and the backward elasticity of the elastic element makes the second magnetic element be returnable to the first position.

4. The magnetic lock device of claim 1, wherein the first magnetic element and the second magnetic element are magnets.

5. The magnetic lock device of claim 1, wherein the first magnetic element or the second magnetic element is an electromagnet.

6. The magnetic lock device of claim 3, wherein the touch element is a push-button.

7. The magnetic lock device of claim 3, wherein the touch element is a press-key.

8. The magnetic lock device of claim 3, wherein the elastic element is a spring.

9. The magnetic lock device of claim 1, wherein the first body is a monitor.

10. The magnetic lock device of claim 1, wherein the first body is a host.

11. The electronic apparatus, comprising
a first body;
a second body, which is pivoted on the first body;
a first magnetic element, which is located on the first body and comprises a first part and a second part, wherein the first part has a first polarity and the second part has a second polarity;
a second magnetic element, which is located on the second body and comprises a third part and a fourth part, wherein the third part has the first polarity and the fourth part has the second polarity, the second polarity is opposite to the first polarity, and when the first body and the second body are closed, the first part faces to the fourth part for providing a magnetic attraction between the first body and the second body; and
a control module, which is located on the second body, wherein when the control module is triggered, the first part faces to the third part for providing a magnetic repulsion between the first body and the second body.

12. The electronic apparatus of claim 11, wherein the second magnetic element is moved corresponding to the control module, the control module controls the second element to move between a first position and a second position, the first part faces the fourth part when the second magnetic element located on the first position, and the first part faces the third part when the second magnetic element located on the second position.

13. The electronic apparatus of claim 11, wherein the control module comprises a touch element, a bearing element, an elastic element and a blocking element, the touch element connects to the bearing element on which the second magnetic element set, the blocking element is set in the second body, the elastic element is located between the blocking element and the bearing element, when the touch element is moved by a outside force in a first direction and drives the second magnetic element to the second position, the elastic element is moved in a second direction by a backward elasticity of the elastic element due to the elastic element is restricted by the blocking element, the second direction is opposite to the first direction, and the backward elasticity of the elastic element makes the second magnetic element be returnable to the first position.

14. The electronic apparatus of claim 11, wherein the first magnetic element and the second magnetic element are magnets.

15. The electronic apparatus of claim 11, wherein the first magnetic element or the second magnetic element is an electromagnet.

16. The electronic apparatus of claim 13, wherein the touch element is a push-button.

17. The electronic apparatus of claim 13, wherein the touch element is a press-key.

18. The electronic apparatus of claim 13, wherein the elastic element is a spring.

19. The electronic apparatus of claim 11, wherein the first body is a monitor.

20. The electronic apparatus of claim 11, wherein the first body is a host.
